(19) United States
(12) Patent Application Publication
(10) Pub. No.: US 2023/0230008 A1
(43) Pub. Date: Jul. 20, 2023

(54) Strategic Innovation and Strategic Management Software

(71) Applicant: Malek Mia Arroyo, West Windsor, NJ (US)

(72) Inventor: Malek Mia Arroyo, West Windsor, NJ (US)

(21) Appl. No.: 18/096,552

(22) Filed: Jan. 12, 2023

Related U.S. Application Data
(60) Provisional application No. 63/300,399, filed on Jan. 18, 2022.

(51) Int. Cl. G06Q 10/0637

(52) U.S. Cl. CPC G06Q 10/06375

(57) ABSTRACT

The present invention comprises a novel innovation and strategic management software application consisting of an automated method and system for receiving business information and data from a user describing the business products, services and strategy and finances to translate to generated systems, processes and enhanced outcomes. Utilizing artificial intelligence and machine learning for language processing, automated systems render business innovation and strategy models, position business, products and services and performs the management of these. Management of services and processes are communicated through the software application. Communication of project status, tasks and performance are indicated alongside other communications such as audio, visual/video text, and data intelligence which are transferable between internal and external users or team members in the application. Curated education, customized analytics, and insights promote a robust system for information retrieval for users of the application that together provide enhanced competitive competencies.

### FIELD OF THE INVENTION

The field of disclosure relates in general to business and the utilization of strategic innovation and strategic management processes to increase business competitiveness.

### BACKGROUND

The outcome of business success can be directly tied to its strategies and competitiveness. Business growth through strategic innovation entails the activities of creating enhanced value and delivering new products, services or business models by identifying gaps in the market, redesigning strategy and utilizing technology adaptation allows a business to progress in an ascending manner typically referring to increase in size or profits. The utilization of strategic management entails the process of setting goals, procedures, and objectives in order to make a company or organization more competitive. This often includes strategy evaluation, internal organization analysis, and strategy execution throughout the company for the growth of an organization.

The market place is constantly changing to and adapting to new and novel inventions every day. Where we need to see improvements is the way that business innovation and business strategy are utilized in alignment throughout all the areas and types of innovation even from the very inception of a company. Creating this systemized approach of processes that allow business strategy and innovation to work conjunctively throughout the organization develops a secure outcome in the market and for investors when utilized properly. Many times companies seek consultants and capital for growth and hopes to produce their company product and/or service vision, mission and execute their goals with little structure to sustain, or pivot indefinitely.

It can be disastrous when companies are unable to either satisfy the market with the number of sales, or satisfy the market with sustainable performance or ascending profits suitable for the return on investments. The impact of the aforementioned can tarry for years and be disastrous for investors, customers/clients when or service or product fails. Unfortunately finances from investments are not the only valuable loss sustained when a company fails. There are costs, time, risks and effort and other scarifies associated with hopes to achieve business growth or success. When there is not a system set up to cushion a failed attempt to market, or a system not set up to accelerate a business while warding off competitors, the business is incredibly vulnerable.

There are current software tools that exist which facilitate strategies such as innovation tools, innovation strategy tools, and strategy tools, strategy management tools, as well as many consulting firms who may also operate services online. The drawback is that these services in particular are often offered in silos and at best innovation services are often linked to overall company strategy. In many instances these software tools are designed in particular for large companies. In other instances companies opt for hiring consultants. Companies can find they are either dissatisfied with consultants or paying more than they prefer for services over time.

The quest for the return on investments, profits and company growth perpetuates companies of all sizes, yet business failure is still rather prevalent at the rate of 70% for start ups, by year 10, overall the precedence is that 90% of businesses fail altogether in the US according to US labor statistics. Furthermore, for the larger business contenders, they are now easily being disrupted.

Therefore, a need exists in the field of business for a robust tool and system that properly enhances the outcomes of businesses utilizing the dual innovation strategy and strategy management approach within a software that can be widely accessed and available to assist in obtaining business success in a way that addresses these matters easily and proficiently. When utilized, this system deflects and disposes business failure and the conditions that lead to it, while addressing innovation, derailing stagnation, confirming market fit and aligning desired outcomes with the appropriate return on investments for business strategy success or outcomes. Further, the need exists for there to be automated management of the collective and encompassing innovation, innovation strategy and strategy software tools for companies of all sizes that facilitates the communication and experience between clients, consultants and managers. Finally there is a need for the innovation, strategy and the management of the two in a software that comprises artificial intelligence so that it can respond intelligently and quickly to each individual company's needs, gather deep insights, reducing the problems related to long product or services time to market, problems while in the market, as well as related associated risks and costs.

### BRIEF SUMMARY OF THE INVENTION

The present invention comprises a multilayer software strategy and innovation tool that provides management and addresses business competitive readiness utilizing innovation, innovation strategy, strategy management, communications, education, and delivers automation with AI, analytics and where there are transactions the ability to utilize blockchain technology. The present invention allows customization and automation of tasks and management, systems and processes with the aid of artificial intelligence and analytics. Communications about strategy status, monitoring and implementation tasks are delivered to companies using the software. Managers and/or consultants may use the software facilitate deliverables and processes manually or through the use of the AI functions. The present invention formulates its basis for automation on deep learning and devises a combination of processes, structures and functions so they become systemized making ease of management in key areas accessible for the businesses that utilize the invention no matter the size of the company or the type of product or service being offered.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is a diagram which depicts the implementation steps and user flow to initiate use of the software application.

FIG. 2 depicts a screen shot perspective view of the elements that comprise the main page embodiments and some of its functionalities of the present invention.

FIG. 3 depicts a screen shot perspective view of the elements that comprise the tasks page embodiments and some of its functionalities of the present invention.

FIG. 4 illustrates a screen shot perspective view of the elements that comprise the communications page embodiments and some of its functionalities of the present invention.

FIG. 5 illustrates a screen shot perspective view of the elements that comprise the dashboard page embodiments and some of its functionalities of the present invention.

FIG. 6 illustrates a screen shot perspective view of the elements that may comprise the strategy page and some of its functionalities of the present invention.

FIG. 7 illustrates a screen shot perspective view of the elements that comprise strategy sub-page and some of its functionalities of the present invention.

FIG. 8 illustrates a screen shot perspective view of the elements that comprise the innovation page embodiments and some of its functionalities of the present invention.

FIG. 9 illustrates a screen shot perspective view of elements comprising the innovation sub-section page embodiments and some of its functionalities of the present invention.

FIG. 10 illustrates a screen shot perspective view of elements comprising the finances sub-section of the strategy page embodiments and some of its functionalities of the present invention.

### DETAILED DESCRIPTION OF THE DRAWINGS

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, embodiments, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques, functions, capabilities and/or steps are disclosed. Each of these has individual benefit and each can also be used in conjunction with one or more, or in some cases all, of the other disclosed techniques or functionalities. Accordingly, for the sake of clarity, this description will refrain from repeating every possible combination of the individual capabilities, functions or steps in an unnecessary fashion. Nevertheless, the specification and claims should be read with the understanding that such combinations are entirely within the scope of the invention and the claims.

New strategic innovation, strategic management, Artificial Intelligence blockchain software are discussed herein. In the following description, for purposes of explanation, numerous specific details are set forth in order to provide a thorough understanding of the present invention. In the following description, for purposes of explanation, numerous specific details are set forth in order to provide a thorough understanding of the present invention. It will be evident, however to one skilled in the art that the present invention may be practiced without these specific details.

The present disclosure is to be considered as an exemplification of the invention, and is not intended to limit the invention to the specific embodiments illustrated by the figures or description below.

The inventor provides a unique software application for automated strategic innovation and strategic management processes for businesses. The new software application incorporates the two strategic objective and processes along with AI and analytics to enable deep learning, ease of use and customization as well as blockchain capabilities for financial transactions.

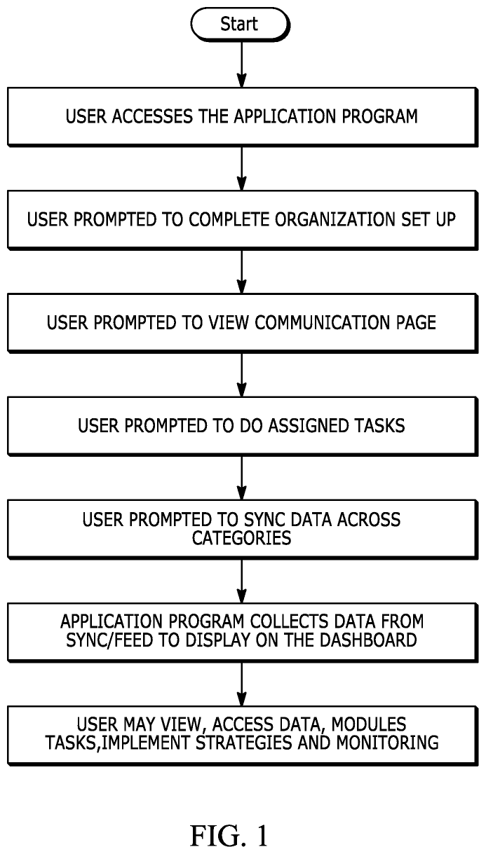

The present invention is described in enabling details in the following examples, by referencing the appended figures which may represent more than one embodiment of the present invention. FIG. 1 represents the business user flow for the main user of the innovation and strategic management application as it depicts the general initial steps taken from login start to inception of implementation and monitoring of strategy and innovation. At the inception of the user agreement and login the initiates the start of the application 10, once the user accesses the application 12, the user is prompted to complete organization set up 14. The user is then prompted view data in the communication page 16. The user is then prompted to do assigned tasks 18. The user is then prompted to then sync data across functions of interest and customize their dashboards 22. Once data is synced the user may engage the application with access to data, strategies and implementation and monitoring made available 24.

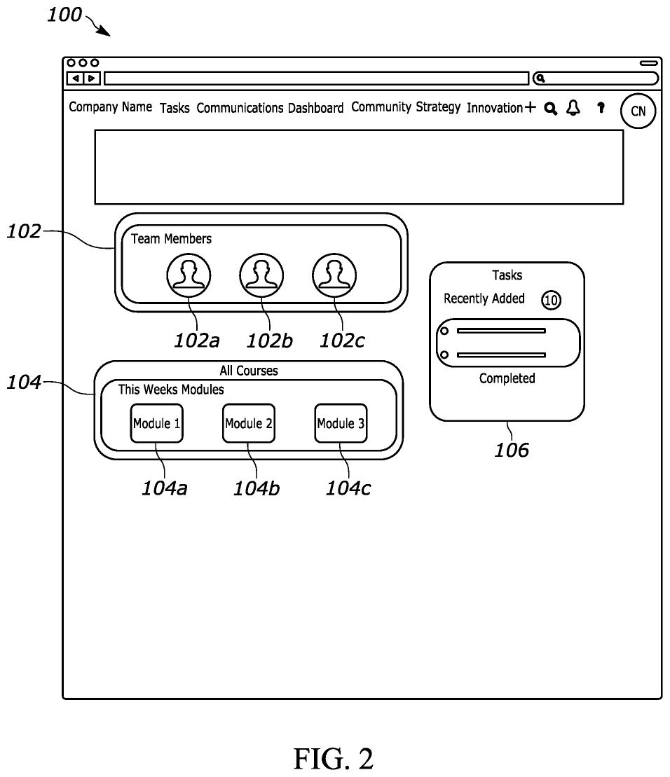

FIG. 2 depicts a screen shot perspective view of the elements that may comprise the main page 100 and its functionalities. The main page 100 provides the user with the company management team profile 102 with each individual and identifiable management team member profile 102a-102c as seen in this example, not limited to the total depicted in this example. The team managers may be selected as AI or manually entered in the software application invention. In addition this page may house the courses 104, and its related modules 104a-104c as seen in this example, not limited to the total depicted in this example. The task box embodiment 106 allows users to access pending assignments, status, number of tasks, and immediate access to view and/or complete them. Access to tasks assigned for either the team members or user to accomplish are presented by box 106. This embodiment identifies the number of tasks added since the last log in, and tasks completed access. A more expanded view of all embodiments on this page is available when each embodiment is selected. Each element is housed in its own element box according to various embodiments described herein.

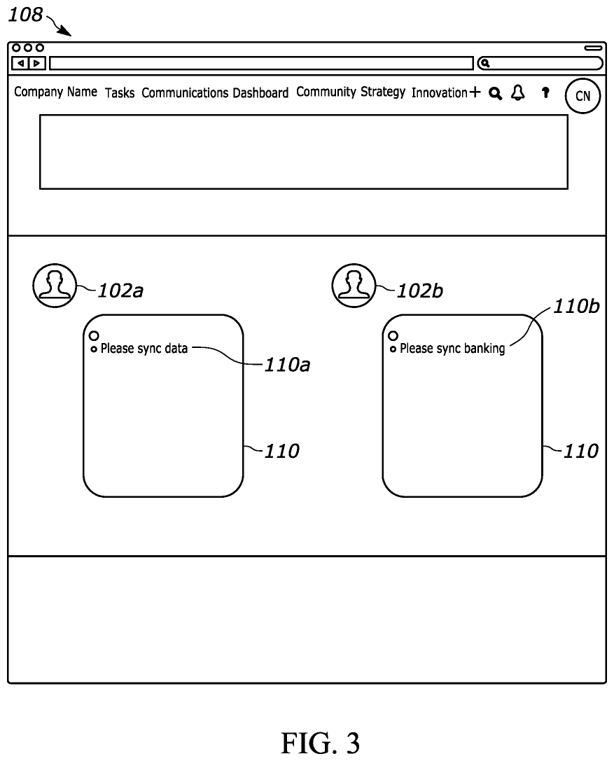

FIG. 3 depicts a screen shot perspective view of the elements that may comprise the tasks page 108 and its functionality within the innovation and strategic management software application. The tasks page may consist of an individual team/manager profile 102a identified as the communicator to the user, within the team/management communicator box 110 displaying crucial or pertinent pending task(s) assigned. Each element is housed in its own element box according to various embodiments described herein. In this example, the user is presented a task to view for completion 110, and user is prompted to sync their related data 110a and/or banking 110b using credentials or similar means to collect the 3rd party information which may be by autofeed to populate and house with additional data in the cloud recognized by the software application in real time. As a part of the preliminary set up, tasks are categorized by focus area.

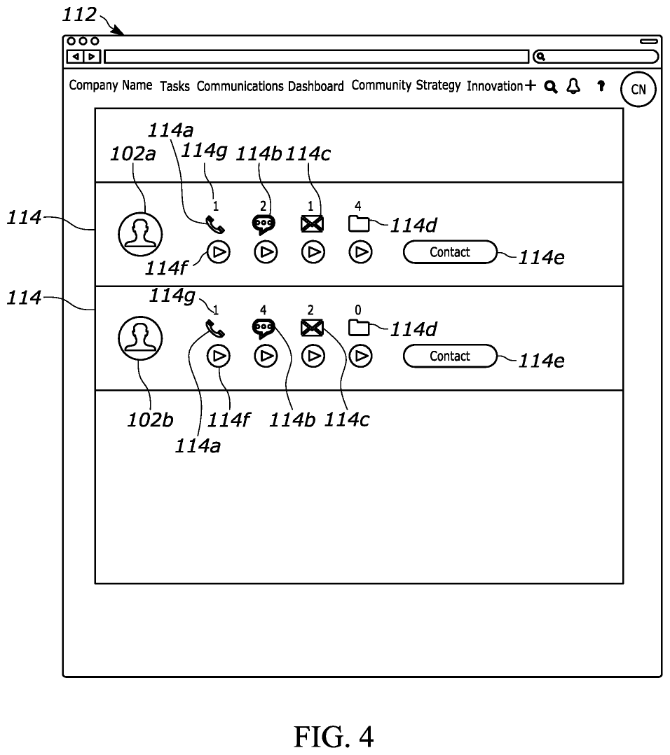

FIG. 4 illustrates an example of a screen shot view of the communications page 112 and its functionality where the user may view the communication box 114 from each team/management member and select from a host of communication icons not limited to 114a-114e. In this example the commination icons include and are not limited phone 114a, chat message 114b, email 114c and data/files 114d and a contact connection button 114e. In this example users may access messages by pressing the arrow underneath the representative communication icon 114f and/or respond to have real time communications within the application through the contact connection button. Communications sections of the invention may include but are not limited to phone, chat, email, video, data/file. The digits housed above each type of communication icon 114g serves as a notification detailing the number of communications messages stored that await the user to review.

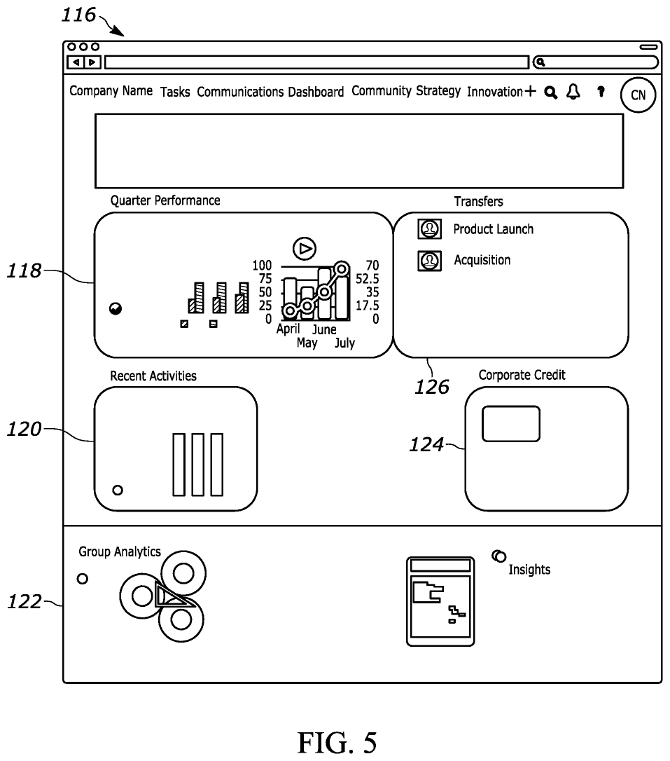

FIG. 5 illustrates a screen shot perspective view of the elements that comprise the dashboard page 116 and some of its functionalities where the user may view visual representations of data. The data may include but is not limited to performance, analytics and/or any information specified for display. The dashboard may be customized and may include custom data feeds, analytics and specifics related to the particular company user data. In this instance we see in one of the embodiments of the dashboard page the quarterly revenue performance 118. The embodiment recent activities 120 features relevant recent activity data for the user. A user may also decide or be recommended to utilize different features of the analytics insights panel 122. In this instance, the analytics and insights have generated a custom set of analytic data sets and insight reports deployed from the artificial intelligence analysis queries. In addition we may also see for example data regarding corporate credit accounts 124. Other specified data related to transfers may include allocation of amounts, dates of transfers and relative information regarding the funds going in and out of the corporate account 126. The embodiments within this page functionality may be based on system recommendations or preferred user custom insights.

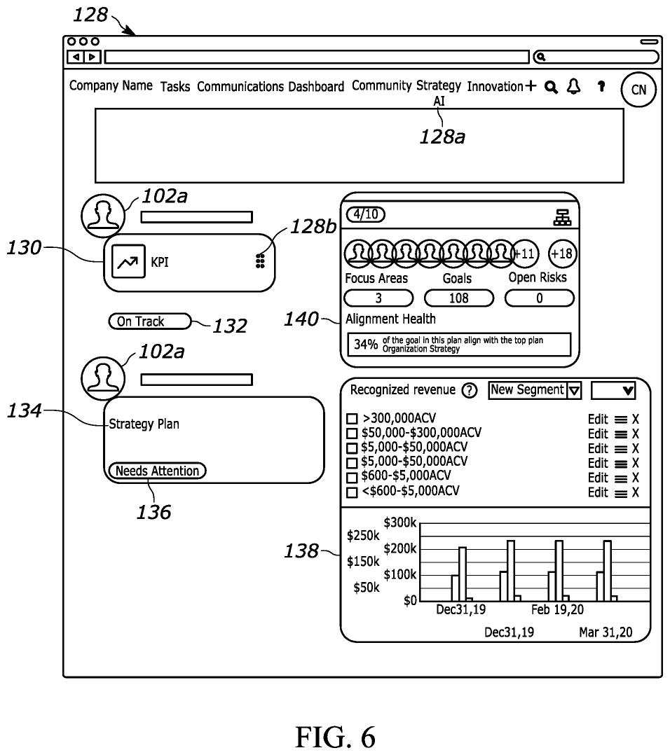

FIG. 6 illustrates a screen shot perspective view of the elements that comprise the strategy page 128 and some of its functionalities. The differing box embodiments detail communications between the platform, app and the user. In this depiction, the application Artificial Intelligence (AI) and Machine Learning (ML) have carried out both strategic and analytic customized tasks in the strategy category and each communication box is updated in real time to reflect some of the data. One of those requires input or review from the user. On the menu bar, the strategy area once hovered over allows for several differing options for out put with this function from the drop down area 128a. In this example AI is featured, the present invention includes but is not limited to the AI functions in the strategy category. In addition there are sections within the embodiments where authorized or otherwise specified users may access and edit the analysis or other feature parameters for their company or systems 128b. Visual snapshots of information related to the users strategy is reflected throughout the strategy page in real time with performance feeds, data, prompts and alerts indicating information related to strategy performance 130-140. In this instance through the differing box embodiments the user is presented with the visual outcome in differing forms including but not limited to graph representations, and can be generated manually or automated by AI. The user may need to click on a specified box embodiment for additional visuals/information for that category. As depicted here, the management/team 102a alerts the users through communication of related strategy data based on the assigned role. An embodiment representing KPI data 130 and its status, alert, and/or prompt below awaits the user to click/select for further details and/or instructions 132. A strategy plan embodiment box 134 highlighting strategy plan information and its status, alert button and/or prompt below 136 awaits the user to select for further details and/or instructions. The related revenue embodiment box 138 details revenue data across differing segments. Also in this example, go to market data is available for the user to view in the embodiment box 140 detailing the percentage of alignment with the strategy in real time.

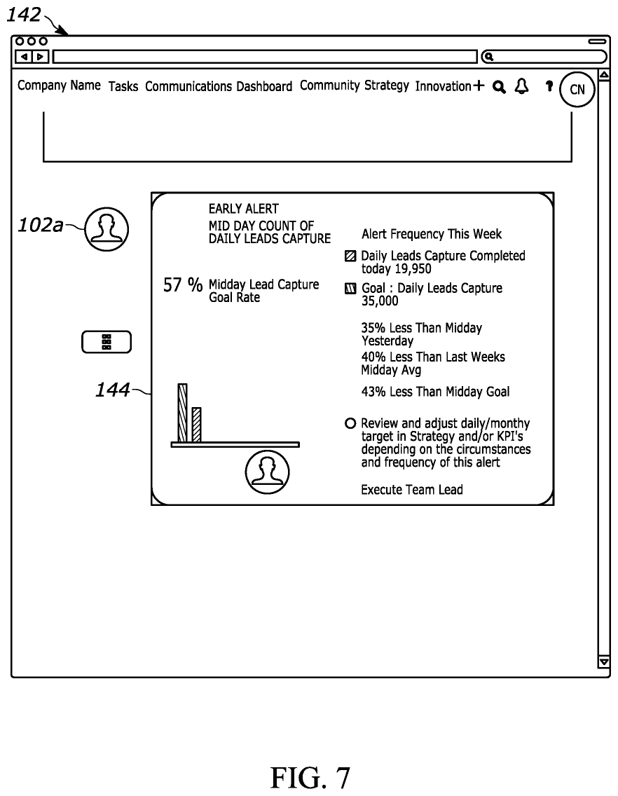

FIG. 7 illustrates a screen shot perspective view of the elements that may comprise the strategy page sub section 142 and some of its functionalities where once selected, more granular analytics are accessed from the previous strategy plan embodiment 134. Here the user may view the data customized for this section. The depiction represents only one of the many differing strategy subsections and its functionalities. Also in this example the embodiment of data 144 expresses where AI and ML have identified a problem with the strategy and alignment based on requirements for the time of day. An alert triggered before KPI indicators are typically triggered. This feature was set for early attention and response. The responsible team member/role 102a is identified along with alerts and analysis along with advice on how to solve the strategy alignment concern. Autosave features capture and save previous versions of setup instructions and system data.

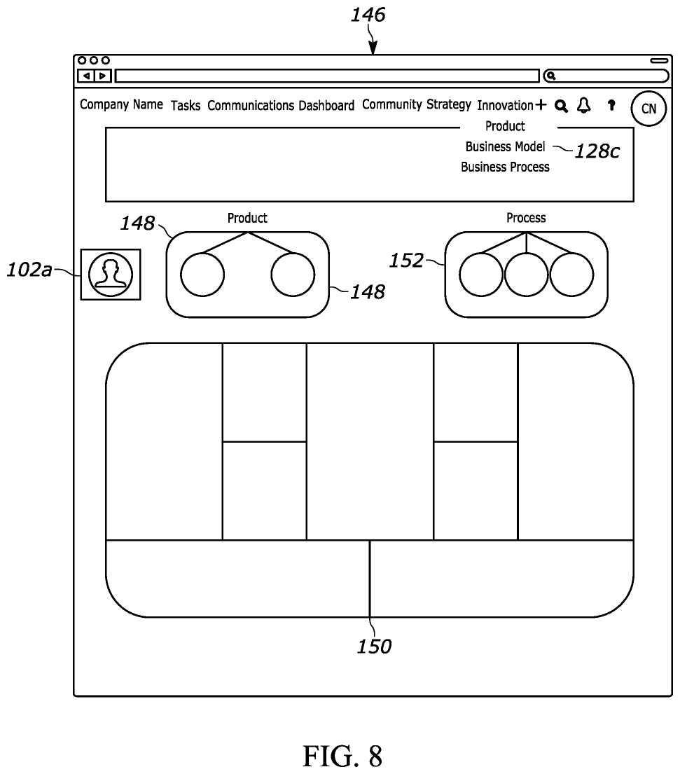

FIG. 8 illustrates a screen shot perspective view of the elements that may comprise the innovation page 146 and some of its functionalities where innovation models are autogenerated based on the customization and scope of data. On the menu bar, the innovation area once hovered over allows for several differing options for out put with this function from the drop down area 128c. In this example embodiments for innovation of the business product 148, business model 150, and business processes 152 are featured. The present invention includes but is not limited to those 3 functions in the innovation category. Also in this example the differing box embodiments visually update for differing categories of focus for business innovation and allow the user to view visual adaptations of their strategy/plan which can be either automated through AI manager or manually generated. The user may need to click on a specified box embodiment for additional visuals/information for that category.

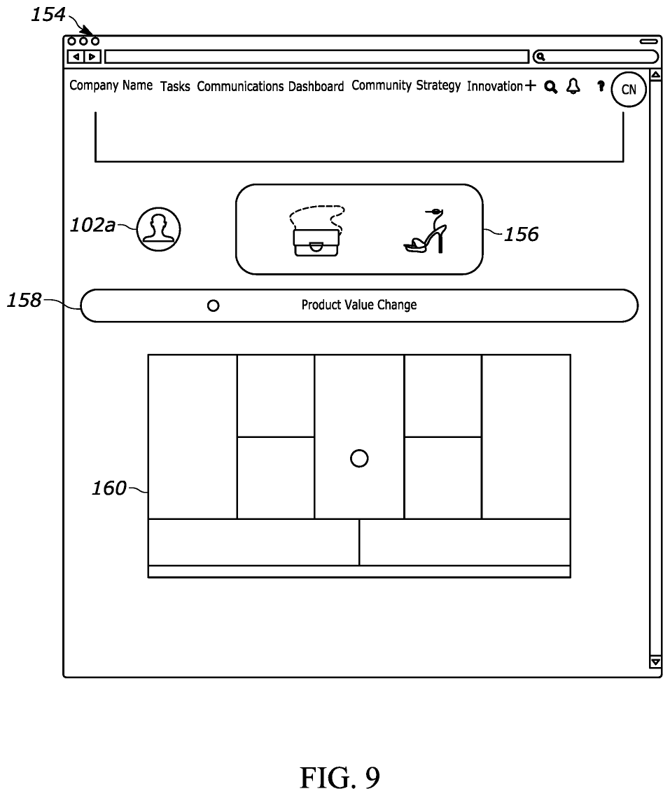

FIG. 9 illustrates a screen shot perspective view of elements that may comprise the innovation management sub-section page 154 and some of its functionalities and embodiments where parts of the business model are made visible in actualized format to the user 156. In this instance the differing box embodiments detail the results of completed actions within the sections of the business model including updates, adaptations, etc, that may alter the business in any way. Also in this example he business model changes result in a view of new product or product prototype for the user to view. The user also is notified of changes to value/financial data 158 along with indications in the business model canvas detailing where the change was made from the previous version 160. The application providers users the opportunity to save the previous versions data.

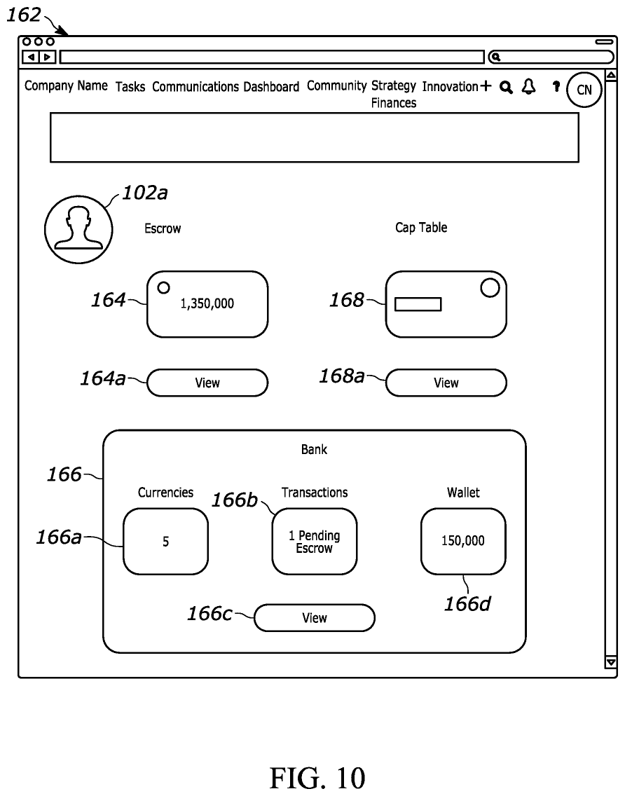

FIG. 10 illustrates a screen shot perspective view of elements comprising the finances sub-section of the strategy page 162 and some of its embodiments and functionalities within the present invention. This page functionality features financial data monitoring and control. Data including any modifications made to strategic plan finances are visible to the user. In this instance finances help in escrow and all activities are housed in the escrow embodiment 164. Through the bank embodiment 166 the user accesses the differing range of banking data and functions including and not limited to 166a-166c. The cap table embodiment details financial data related to the cap table 168. Users may explore a more expanded and expounded view of existing data through view buttons 164a, 166c, 168a housed below the escrow and cap table data. Users may also customize the available data housed within the finance sections as well as levels of accessibility of the team members/management accessing the data in the present invention.

It will be apparent to one in with skill in the art that the strategic innovation, and strategic management software application automation services of the invention may be provided using some or all of the mentioned capabilities, features, functions and components without departing from the spirit and scope of the present invention. It will also be apparent to the skilled artisan that the embodiments described above are specific examples of a single broader invention which may have greater scope than any of the singular descriptions taught. Alterations may be made in the descriptions without departing from the spirit and scope of the present invention.

What is claimed is:

1. An automated method and system for business innovation and strategy management comprising receiving business information and data from a user, the information and data describing the business products, services, activities and processes which produces the objectives, plans, insights and measures to delineate desired business outcomes.

2. An automated method and system for business innovation and strategy management comprising of business information and data performing language processing to generate a language model, the language model including a representation of the desired business products, services and strategy outcomes.

3. An automated method and system for business innovation and strategy management comprising deep learning and use artificial intelligence for the analysis, generation of models, communications and use of data for strategy outcomes.

4. An automated method and system for business innovation and strategy management comprising transmittal of communications, educational modules including but not limited to transmittal via video, audio, text, data/intelligence communications to and from the users of the software application.

5. An automated method and system for business innovation and strategy management comprising of customized and/or pre-specified algorithms, for the use of determining investment activities such as but not limited to stock calculations, projections and valuations, cap tables for business and investment strategy.
